(19) United States
(12) Patent Application Publication
(10) Pub. No.: US 2025/0128759 A1
(43) Pub. Date: Apr. 24, 2025

(54) STEERING GEAR FOR A STEER-BY-WIRE STEERING DEVICE AND STEER-BY-WIRE STEERING DEVICE WITH SUCH A STEERING GEAR

(71) Applicant: ZF Automotive Italia S.r.l., Torino (IT)

(72) Inventor: Jacopo CABASSI, Torino (IT)

(21) Appl. No.: 18/920,027

(22) Filed: Oct. 18, 2024

(30) Foreign Application Priority Data
Oct. 19, 2023 (DE) 10 2023 210 317.6

(51) Int. Cl. B62D 5/04

(52) U.S. Cl. CPC B62D 5/0481; B62D 5/0445

(57) ABSTRACT

The invention relates to a steering gear (1) for a steer-by-wire steering device and with a steering rod (4), with a steering rod housing (11), and with a slide bearing bush (12) arranged between the steering rod housing (11) and a steering rod portion (13) of the steering rod (4), wherein the slide bearing bush (12) is fixedly attached to the steering rod housing (11), and the steering rod portion (13) and the slide bearing bush (12) engage with one another in such a way that a rotational movement of the steering rod (4) is blocked and a translational displacement of the steering rod (4) in the axial direction of the central longitudinal axis (5) of the steering rod (4) is allowed. In order to provide a redundancy function in the event of a defect or failure of the slide bearing bush (12), the steering gear (1) is characterized in that the slide bearing bush (12) forms a first anti-rotation component (15) and a second anti-rotation component (16) is arranged between the steering rod housing (11) and the steering rod (4), wherein a fail-safe protection is realized by means of the second anti-rotation component (16) in the event of a defect in the first anti-rotation component (15).

### TECHNICAL FIELD

The invention relates to a steering gear for a steer-by-wire steering device and with a steering rod, wherein the steering rod is connected to an electric drive by means of a transmission device, and the transmission device is designed to convert a rotational movement of the electric drive into a translational movement of the steering rod in the axial direction of a central longitudinal axis of the steering rod, and with a steering rod housing in which the steering rod is at least partially arranged, and with a slide bearing bush arranged between the steering rod housing and a steering rod portion of the steering rod, wherein the slide bearing bush is fixedly attached to the steering rod housing, and the steering rod portion and the slide bearing bush engage with one another in such a way that a rotational movement of the steering rod is blocked and a translational displacement of the steering rod in the axial direction of the central longitudinal axis of the steering rod is possible. Furthermore, the invention relates to a steer-by-wire steering device with such a steering gear.

### BACKGROUND

Such a steering gear and such a steer-by-wire steering device are known from DE 10 2018 124 905 A1.

A steer-by-wire steering system has no mechanical connection between the steering handle or steering wheel and the vehicle wheels, which is why such steering systems have a simulator unit to give the driver feedback. The simulator unit simulates the steering forces occurring at the steered vehicle wheel and thus gives the driver an impression of the steering condition. For this purpose, the simulator unit has a feedback drive which is attached to a steering shaft, which in turn is connected to the steering wheel. The forces transmitted to the steering wheel by means of the feedback drive can be controlled by means of a control device.

The steering gear can be used to steer the wheels of a vehicle. In particular, the steering rod of the steering gear is connected to the wheels of the vehicle, preferably via tie rods and/or wheel carriers. In order to move the steering rod longitudinally, it is necessary that it is mounted in such a way that rotational movement about the central longitudinal axis of the steering rod is blocked. This is achieved by the slide bearing bush, in which the steering rod portion is mounted so that it can slide exclusively in the longitudinal direction of the central longitudinal axis.

In order to meet safety requirements or failure requirements, it may be necessary to provide a redundancy function with respect to the slide bearing bush. The redundancy function is intended to ensure that in the event of a defect or failure of the slide bearing bush, the steering rod cannot rotate freely around the central longitudinal axis and thus the function of the steering gear is still ensured.

### SUMMARY

It is the object of the invention to further develop a steering gear and/or a steer-by-wire steering device of the type mentioned at the outset in such a way that a redundancy function is provided in the event of a defect or failure of the slide bearing bush. In particular, an alternative embodiment is to be provided.

The object of the invention is achieved with a steering gear according to claim 1 and/or with a steer-by-wire steering device according to claim 10. Preferred developments of the invention will be apparent from the dependent claims and the following description.

The steering gear is designed for a steer-by-wire steering device. In particular, the steering gear and/or the steer-by-wire steering device are designed for a vehicle, in particular a motor vehicle. The steering gear has a steering rod. In particular, the steering rod can be used to steer the wheels of a vehicle or motor vehicle. The steering rod may alternatively be referred to as a steering rod. The steering rod is connected to an electric drive via a transmission device. Here, the transmission device is designed to convert a rotational movement of the electric drive into a translational movement of the steering rod in the axial direction of a central longitudinal axis of the steering rod. For example, the transmission device can have a ball screw drive. Preferably, the steering rod is displaceable in the longitudinal direction of the central longitudinal axis by means of the electric drive and the transmission device.

Furthermore, the steering gear has a steering rod housing in which the steering rod is at least partially arranged. In particular, the steering rod is slidably mounted in the steering rod housing. The steering rod can extend outwards from the steering rod housing at two opposite ends. The outer ends of the steering rod can each be connected, in particular by means of a tie rod, to a wheel carrier for a wheel to be steered.

A slide bearing bush is arranged between the steering rod housing and a steering rod portion of the steering rod, wherein the slide bearing bush is fixedly attached to the steering rod housing. In particular, the slide bearing bush is designed like a sleeve. The slide bearing bush can be held and/or fastened to the steering rod housing in a form-fitting, force-fitting and/or material-fitting manner.

The steering rod portion and the slide bearing bush engage with each other in such a way that a rotational movement of the steering rod, in particular about the central longitudinal axis of the steering rod, is blocked and a translational displacement or shifting of the steering rod in the axial direction of the central longitudinal axis of the steering rod is possible. Thus, the steering rod is blocked against rotation about the central longitudinal axis of the steering rod by means of the slide bearing bush, thereby realizing an effective and cost-effective bearing of the steering rod for the transverse or linear displacement of the steering rod.

According to the invention, the slide bearing bush thus forms a first anti-rotation component, wherein in addition to the first anti-rotation component, a second anti-rotation component is arranged between the steering rod housing and the steering rod, wherein by means of the second anti-rotation component a fail-safe device is realized in the event of a defect in the first anti-rotation component.

The advantage here is that the second anti-rotation component provides a redundancy function in the event of a defect or failure of the slide bearing bush or the first anti-rotation component. For this purpose, the first anti-rotation component and the second anti-rotation component are designed as independent components.

The second anti-rotation component may be disposed between the steering rod housing and the steering rod portion of the steering rod. In particular, the steering rod portion for the second anti-rotation component is the same steering rod portion as for the first anti-rotation component. The second anti-rotation component may be disposed between the steering rod housing and the steering rod portion of the steering rod. In particular, the further steering rod portion is designed as a separate and/or independent steering rod portion in relation to the steering rod portion for the first anti-rotation component. The second anti-rotation component can be ring-shaped or ring-disk-shaped.

In particular, the second anti-rotation component has an outer circumference directed radially to the central longitudinal axis and an inner circumference, wherein the inner circumference has a component-side inner contour which is designed to correspond to a steering rod-side outer contour of the steering rod and/or of the, in particular further, steering rod portion. Preferably, the component-side inner contour or the steering rod-side outer contour is non-circular or polygonal-shaped or polygonal. For example, the component-side inner contour or the steering rod-side outer contour can be quadrangular, in particular square, or triangular when viewed in the direction of the central longitudinal axis.

According to a further development, when the first anti-rotation component is functioning normally, a free gap is formed between the component-side inner contour and the steering rod-side outer contour, whereby the second anti-rotation component does not interact with the steering rod and/or the, in particular, further steering rod portion when the first anti-rotation component is functioning normally. Thus, when the first anti-rotation component or the slide bearing bush fulfills its intended function, namely to prevent the steering rod from rotating about the central longitudinal axis, the second anti-rotation component and the steering rod and/or the, in particular, further steering rod portion are not in direct contact due to the free gap. In this way, additional friction between the second anti-rotation component and the steering rod and/or the, in particular, further steering rod portion, which is unnecessary in the normal function of the first anti-rotation component, can be avoided.

Preferably, in the event of a malfunction and/or failure of the first anti-rotation component, the steering rod-side outer contour of the steering rod strikes the component-side inner contour of the second anti-rotation component in the circumferential direction around the central longitudinal axis, so that a rotational movement of the steering rod is blocked and a translational displacement of the steering rod in the axial direction of the central longitudinal axis of the steering rod is possible. Thus, the second anti-rotation component and the steering rod only interact after a defect and/or failure of the first anti-rotation component. As a result, the second anti-rotation component provides the desired redundancy function with regard to blocking free rotation of the steering rod around the central longitudinal axis.

According to a further embodiment, in the event of malfunction and/or failure of the first anti-rotation component, at least one line contact or point contact is realized between the steering rod-side outer contour of the steering rod and the component-side inner contour of the second anti-rotation component. The at least one line contact can extend parallel to the central longitudinal axis. According to a further embodiment, in the event of malfunction and/or failure of the first anti-rotation component, multiple line contacts or point contacts are realized between the steering rod-side outer contour of the steering rod and the component-side inner contour of the second anti-rotation component. In this case, the multiple line contacts or point contacts can be distributed, in particular evenly, in the circumferential direction around the central longitudinal axis.

Alternatively, the steering rod-side outer contour of the steering rod and/or the component-side inner contour of the second anti-rotation component can have at least one or more stop surfaces which rest on one another in the event of malfunction and/or failure of the first anti-rotation component. In particular, the stop surfaces are aligned parallel to the central longitudinal axis.

According to a further development, when the component-side inner contour is in contact with the steering rod-side outer contour and/or due to a play between the component-side inner contour and the steering rod-side outer contour, a noise can be perceived as an indication of the malfunction and/or the failure of the first anti-rotation component. For example, the noises alert a driver to a defect in the steering gear, prompting the driver to visit a workshop. The steering rod has rotational play, particularly due to the play between the component-side inner contour and the steering rod-side outer contour. The noises are preferably generated when the steering direction changes and due to the play between the component-side inner contour and the steering rod-side outer contour or due to the rotational play of the steering rod.

Preferably, the rotational play of the steering rod about the central longitudinal axis due to the play between the component-side inner contour and the steering rod-side outer contour is perceptible as an indication of the malfunction and/or failure of the first anti-rotation component. For example, the rotational play of the steering rod can be perceived by a driver as less direct steering compared to normal function.

According to a further embodiment, an outer circumference of the second anti-rotation component has a component-side retaining contour which cooperates with a housing-side retaining contour of the steering rod housing, which is designed to correspond to the component-side retaining contour, for fixing the second anti-rotation component to the steering rod housing. In this case, an interlocking or interaction of the component-side retaining contour with the housing-side retaining contour causes the second anti-rotation component to be fixed to the steering rod housing. Preferably, the component-side retaining contour and the housing-side retaining contour form a form-fitting connection. In particular, the housing-side retaining contour is formed on an inner side and/or front side of the steering rod housing. In addition to the form-fitting connection, the component-side retaining contour and the housing-side retaining contour can be connected to one another by means of a material-fitting and/or force-fitting connection.

Preferably, the component-side retaining contour has multiple projections and/or recesses alternating in the circumferential direction around the central longitudinal axis. In this case, the housing-side retaining contour has further housing-side recesses and/or projections corresponding to the component-side projections and/or recesses. Thus, a component-side projection can engage in a corresponding further housing-side recess and a component-side recess can engage in a further housing-side projection. In particular, the second anti-rotation component is fixed to the joint housing due to the interaction of the component-side projections and/or recesses with the housing-side further recesses and/or projections for blocking a rotational movement about the central longitudinal axis.

A steer-by-wire steering device with a steering gear according to the invention is particularly advantageous. The steer-by-wire steering device may include a steering wheel. The term steering wheel is a synonym for a steering handle of any shape and/or form. In particular, the steering device has a steering shaft. Preferably, the steering shaft is rotatable or rotatably mounted about its central longitudinal axis. The steering shaft can rotate around the central longitudinal axis in two opposite directions. The steering wheel can be located at one end of the steering shaft. The steer-by-wire steering device may include a feedback motor. In this case, the steering shaft can be set into a rotational movement about the central longitudinal axis of the steering shaft by means of the feedback motor, in particular with the interposition of a gear, and/or provide a controllable torque resistance. This allows the driver of a vehicle or motor vehicle with such a steering device to be provided with a feedback about the steering forces acting on the wheels. In particular, the feedback motor is designed as an electric motor. The feedback motor can be arranged at an end of the steering shaft facing away from the steering wheel. Preferably, the steer-by-wire steering device is further developed in accordance with the embodiments explained in connection with the steering gear according to the invention described here.

### BRIEF DESCRIPTION OF THE DRAWINGS

The invention is explained in more detail below with reference to the figures. The same reference symbols refer to the same, similar or functionally identical components or elements. In particular:

FIG. 1 is a sectional side view of a schematically illustrated steering gear according to the invention,

FIG. 2 is a detail of a partially transparent side view of the steering gear according to the invention according to FIG. 1,

FIG. 3 is a detail of a partially transparent perspective side view of the steering gear according to the invention according to FIGS. 1 and 2,

FIG. 4 is a detail of a perspective side view of the steering gear according to the invention according to FIGS. 1 to 3,

FIG. 5 is a detail of a front view of the steering gear according to the invention according to FIGS. 1 to 4 during normal operation of the first anti-rotation component,

FIG. 6 is a detail of a perspective front view of the steering gear according to the invention according to FIGS. 1 to 5 before applying the second anti-rotation component, and

FIG. 7 is a detail of a front view of the steering gear according to the invention according to FIGS. 1 to 6 during normal operation of the first anti-rotation component.

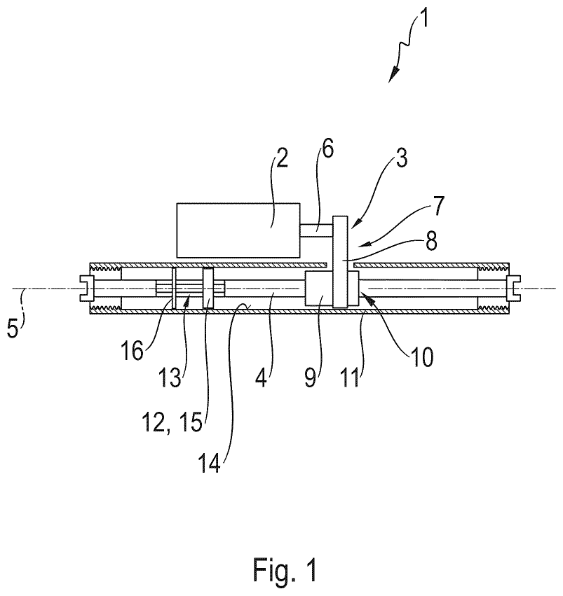

FIG. 1 shows a sectional side view of a schematically illustrated steering gear 1 according to the invention. In this embodiment, the steering gear 1 is part of a steer-by-wire steering device not shown in detail here.

### DESCRIPTION

The steering gear 1 has a drive 2, which is designed here as an electric drive or electric motor. The drive 2 is connected to a steering rod 4 by means of a transmission device 3. Here, the transmission device 3 is designed to convert a rotational movement of the electric drive 2 into a translational movement of the steering rod 4 in the axial direction of a central longitudinal axis 5 of the steering rod 4.

In this embodiment, the drive 2 is connected by means of a drive shaft 6 to a transmission 7, which is implemented here as a belt transmission by way of example. Accordingly, the transmission 7 in this case has a belt 8. In this example, the transmission device 3 or the gear 4 also has a spindle nut element 9, which according to this example can be driven by means of the belt 8. The spindle nut element 9 is rotatably mounted about the central longitudinal axis 5 of the steering rod 4 by means of the drive 2.

For this purpose, the spindle nut element 6 engages with a spindle portion 10 of the steering rod 4. In detail, an inner circumference of the spindle nut element 9 interacts with an outer circumference of the spindle portion 10. In this exemplary embodiment, the spindle nut element 9 interacts with the spindle portion 10 by means of a ball screw drive (not shown in detail here). A displacement of the spindle nut element 9 is blocked in the longitudinal direction of the steering rod 4. At the same time, a twisting or rotation of the steering rod 4 about its central longitudinal axis 5 is blocked, as explained in more detail below. Thus, the steering rod 4 can be displaced in the longitudinal direction of the central longitudinal axis 5 due to a rotation of the spindle nut element 9.

The steering rod 4 extends outwards from a steering rod housing 11 at two opposite ends. Thus, the steering rod 4 is partially arranged within the steering rod housing 11. By means of the steering rod 4, wheels of a vehicle or motor vehicle (not shown in detail here) can be steered.

The steering gear 1 has a slide bearing bush 12 for the steering rod 4. The slide bearing bush 12 is arranged between the steering rod housing 11 and a steering rod portion 13 of the steering rod 4. The slide bearing bush 12 is fixedly attached to the steering rod housing 11 or to an inner side 14 of the steering rod housing 11.

The steering rod portion 13 and the slide bearing bush 12 engage with each other in such a way that a rotational movement of the steering rod 4 is blocked and a translational displacement of the steering rod 4 in the axial direction of the central longitudinal axis 5 is possible. Here, the slide bearing bush 12 provides a first anti-rotation component 15.

Furthermore, the steering gear 1 has a second anti-rotation component 16 which is arranged between the steering rod housing 11 and the steering rod 4, wherein by means of the second anti-rotation component 16, as will be explained in more detail below, a fail-safe protection is implemented in the event of a defect in the first anti-rotation component 15. In this exemplary embodiment, the second anti-rotation component 16 is arranged adjacent to the first anti-rotation component 15 between the steering rod housing 11 and the steering rod portion 13. Here, the second anti-rotation component 16 is fixedly attached to the steering rod housing 11 or to the inner side 14 of the steering rod housing 11.

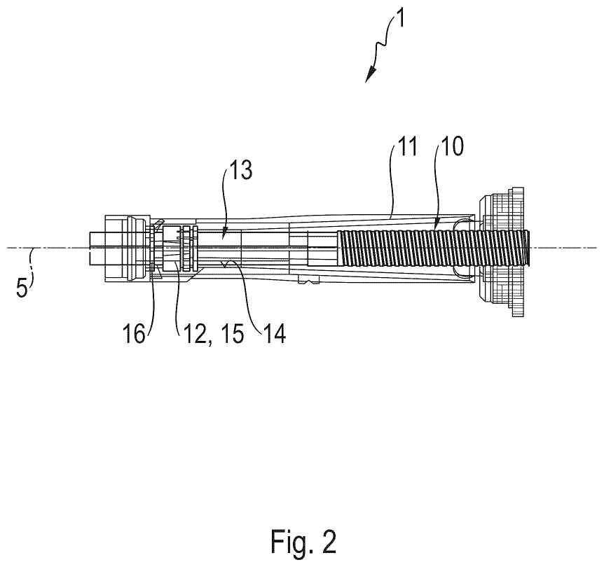

FIG. 2 shows a detail of a partially transparent side view of the steering gear 1 according to the invention according to FIG. 1. While the first anti-rotation component 15 is designed as a slide bearing bush 12 and thus sleeve-like, the second anti-rotation component in this exemplary embodiment is designed like an annular disk.

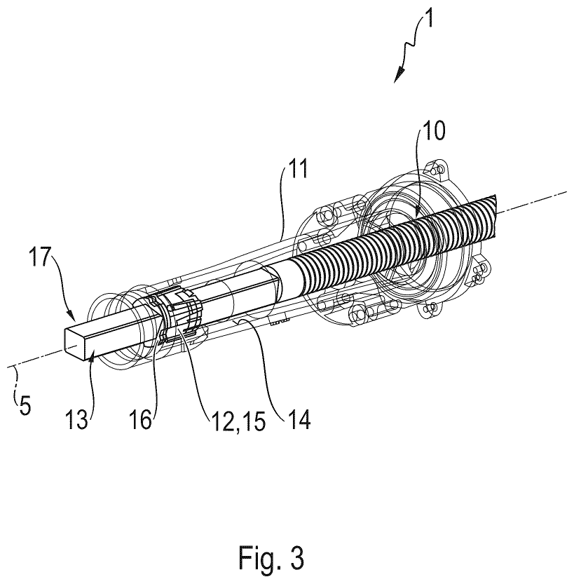

FIG. 3 shows a portion of a partially transparent perspective side view of the steering gear 1 according to the invention according to FIGS. 1 and 2. Among other things, it can be seen that the steering rod portion 13 has a non-round outer contour or a non-circular cross-section when viewed at right angles to the central longitudinal axis 5. In this exemplary embodiment, the steering rod portion 13 has a quadrangular or square steering rod-side outer contour 17.

The slide bearing bush 12 or the first anti-rotation component 15 has an inner circumference, which cannot be seen in more detail here, which corresponds to the steering rod-side outer contour 17, wherein in normal operation of the first anti-rotation component 15 the steering rod-side outer contour 17 and the inner circumference of the first anti-rotation component 15 contact each other in a sliding manner in the longitudinal direction of the central longitudinal axis.

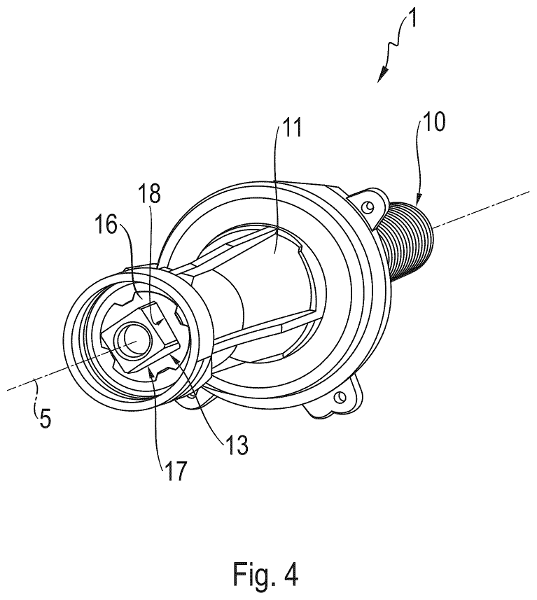

FIG. 4 shows a detail of a perspective side view of the steering gear 1 according to the invention according to FIGS. 1 to 3. The second anti-rotation component 16 has an outer circumference directed radially relative to the central longitudinal axis 5 and an inner circumference, wherein the inner circumference has a component-side inner contour 18. This component-side inner contour 18 is designed to correspond to the steering rod-side outer contour 17.

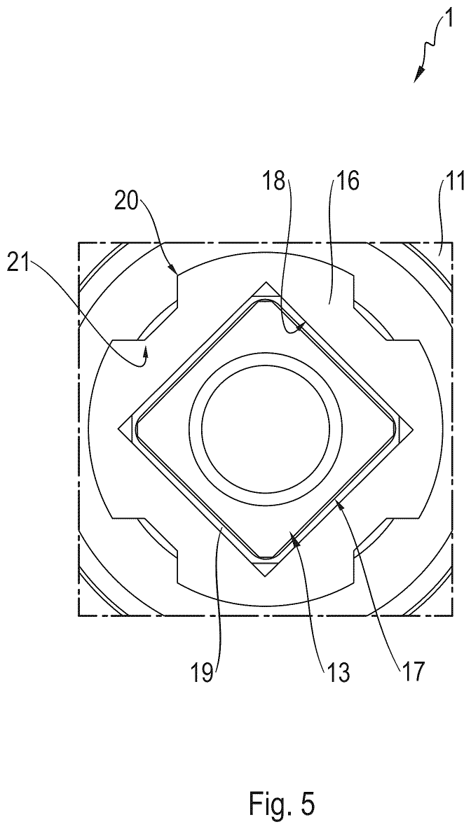

FIG. 5 shows a detail of a front view of the steering gear 1 according to the invention according to FIGS. 1 to 4 during normal operation of the first anti-rotation component 15. It can be seen that when the first anti-rotation component 15 operates normally a circumferential free gap 19 is formed between the component-side inner contour 18 and the steering rod-side outer contour 17. Thus, the second anti-rotation component 16 does not interact with the steering rod 4 or the steering rod portion 13 during normal operation of the first anti-rotation component 15.

An outer circumference of the second anti-rotation component 16 has a component-side retaining contour 20. The component-side retaining contour 20 interacts with a housing-side retaining contour 21 of the steering rod housing 11, which is designed to correspond to the component-side retaining contour 20, for fixing the second anti-rotation component 16 to the steering rod housing 11. Due to the interlocking or interaction of the component-side retaining contour 20 with the housing-side retaining contour 21, the second anti-rotation component 16 is fixed to the steering rod housing 11. In this exemplary embodiment, the component-side retaining contour 20 and the housing-side retaining contour 21 form a form-fitting connection.

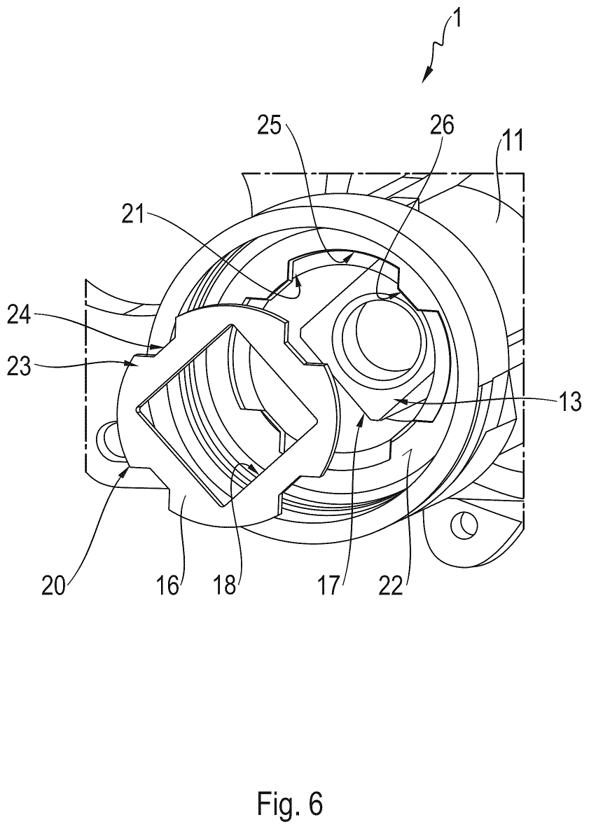

FIG. 6 shows a detail of a perspective front view of the steering gear 1 according to the invention according to FIGS. 1 to 5 before applying the second anti-rotation component 16. In this exemplary embodiment, the housing-side retaining contour 21 is formed on a front side 22 of the steering rod housing 11. In addition, in this exemplary embodiment, the component-side retaining contour 20 and the housing-side retaining contour 21 are connected to one another in addition to the form-fitting connection by means of a force-fitting connection due to the component-side retaining contour 20 being pressed into the housing-side retaining contour 21.

In this exemplary embodiment, the component-side retaining contour 20 has projections 23 and recesses 24 alternating in the circumferential direction. According to this example, the component-side retaining contour 20 has a total of four projections 23 and four recesses 24. Taking into account the illustration in FIG. 4, the projections 23 extend radially outwards to the central longitudinal axis 5 and the recesses 24 extend radially inwards to the central longitudinal axis 5. In this exemplary embodiment, the projections 23 have a convexly outwardly curved outer edge. Furthermore, in this exemplary embodiment, a corner of the component-side inner contour 18 is formed centrally relative to a projection 23.

The housing-side retaining contour 21 has further housing-side recesses 25 and further projections 26 corresponding to the component-side projections 23 and recesses 24. In this case, a component-side projection 23 engages in a correspondingly formed further housing-side recess 25 and a component-side recess 24 engages in a further housing-side projection 26. In relation to the central longitudinal axis 5, not shown in detail here, the further projections 26 extend radially inwards and the further recesses 25 extend radially outwards.

Due to the interaction of the component-side projections 23 and component-side recesses 24 with the housing-side further recesses 25 and housing-side further projections 26, the second anti-rotation component 16 is fixed to the steering rod housing 11.

For the sake of clarity, not all projections 23, recesses 24, further recesses 25 and further projections 26 are provided with a reference symbol.

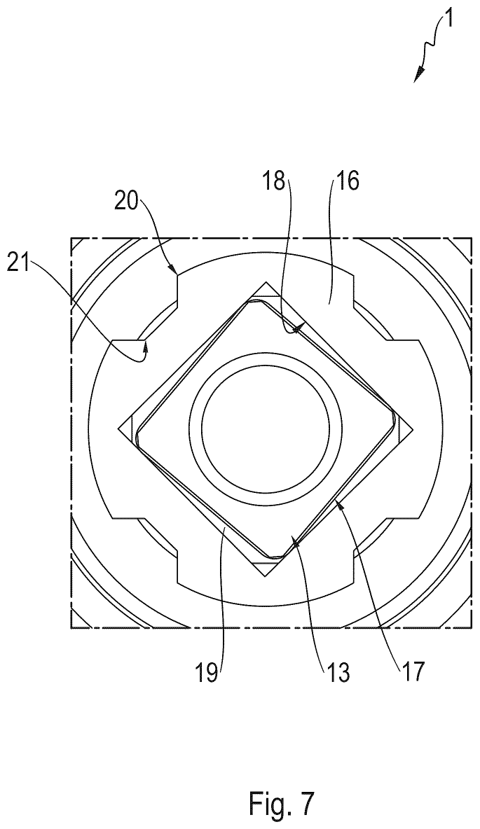

FIG. 7 is a detail of a front view of the steering gear 1 according to the invention according to FIGS. 1 to 6 in case of malfunction or failure of the first anti-rotation component 15.

In the event of a malfunction or failure of the first anti-rotation component 15, the steering rod-side outer contour 17 strikes the component-side inner contour 18 of the second anti-rotation component 16 in the circumferential direction, so that a rotational movement of the steering rod 4 is blocked and a translational displacement of the steering rod 4 in the axial direction of the steering rod 4 is still possible. The second anti-rotation component 16 and the steering rod 4 or the steering rod portion 13 thus only interact after a defect or failure of the first anti-rotation component 15. Thus, the second anti-rotation component 16 provides a redundancy function with regard to blocking a free rotation of the steering rod 4.

Due to the gap 19 between the steering rod portion 13 and the second anti-rotation component 16, a play is realized between the component-side inner contour 18 and the steering rod-side outer contour 17. Due to this play, when the steering rod-side outer contour 17 hits the component-side inner contour 18, a noise is generated as an indication of the malfunction or failure of the first anti-rotation component 15. The play between the component-side inner contour 18 and the steering rod-side outer contour 17 forms a rotational play for the steering rod 4. When the steering direction changes, the noise is generated due to this play. This can alert a driver to the defect in steering gear 1. Moreover, the rotational play of the steering rod 4 can be perceived by a driver as less direct steering compared to normal function.

### REFERENCE NUMERALS

1 steering gear
2 drive
3 transmission device
4 steering rod
5 central longitudinal axis
6 drive shaft
7 transmission
8 belt
9 spindle nut element
10 spindle portion
11 steering rod housing
12 bearing bush
13 steering rod portion
14 inner side
15 first anti-rotation component
16 second anti-rotation component
17 steering rod-side outer contour
18 component-side outer contour
19 gap
20 component-side retaining contour
21 housing-side retaining contour
22 front side
23 projection
24 recess
25 further recess
26 further projection

1. A steering gear for a steer-by-wire steering device and with a steering rod (4), wherein the steering rod (4) is connected to an electric drive (2) by means of a transmission device (3), and the transmission device (3) is designed to convert a rotational movement of the electric drive (2) into a translational movement of the steering rod (4) in the axial direction of a central longitudinal axis (5) of the steering rod (4), and with a steering rod housing (11) in which the steering rod (4) is at least partially arranged, and with a slide bearing bush (12) arranged between the steering rod housing (11) and a steering rod portion (13) of the steering rod (4), wherein the slide bearing bush (12) is fixedly attached to the steering rod housing (11), and the steering rod portion (13) and the slide bearing bush (12) engage in one another in such a way that a rotational movement of the steering rod (4) is blocked and a translational displacement of the steering rod (4) in the axial direction of the central longitudinal axis (5) of the steering rod (4) is possible, the slide bearing bush (12) forming a first anti-rotation component (15) and a second anti-rotation component (16) is arranged between the steering rod housing (11) and the steering rod (4), wherein by means of the second anti-rotation component (16) a fail-safe protection is realized in the event of a defect in the first anti-rotation component (15).

2. The steering gear according to claim 1, wherein the second anti-rotation component (16) is designed in the form of a ring or an annular disk and/or the second anti-rotation component (16) has an outer circumference and an inner circumference directed radially to the central longitudinal axis (5), wherein the inner circumference has a component-side inner contour (18) which is designed to correspond to a steering rod-side (17) outer contour of the steering rod (4).

3. The steering gear according to claim 2, wherein during normal operation of the first anti-rotation component (15) there is a free gap (19) between the component-side inner contour (18) and the steering rod-side outer contour (17), and the second anti-rotation component (16) does not interact with the steering rod (4) during normal operation of the first anti-rotation component (15).

4. The steering gear according to claim 2, wherein in the event of a malfunction and/or failure of the first anti-rotation component (15), the steering rod-side outer contour (17) of the steering rod (4) strikes the component-side inner contour (18) of the second anti-rotation component (16) in the circumferential direction about the central longitudinal axis (5), so that a rotational movement of the steering rod (4) is blocked and a translational displacement of the steering rod (4) in the axial direction of the central longitudinal axis (5) of the steering rod (4) is possible.

5. The steering gear according to claim 4, wherein in the event of malfunction and/or failure of the first anti-rotation component (15), at least one line contact or point contact, in particular multiple line contacts or point contacts, are realized between the steering rod-side outer contour (17) of the steering rod (4) and the component-side inner contour (18) of the second anti-rotation component (16).

6. The steering gear according to claim 4, wherein upon contact of the component-side inner contour (18) with the steering rod-side outer contour (17) and/or due to a play between the component-side inner contour (18) and the steering rod-side outer contour (17), a noise is perceptible as an indication of the malfunction and/or the failure of the first anti-rotation component (15).

7. The steering gear according to claim 4, wherein a rotational play of the steering rod (4) about the central longitudinal axis (5) due to a play between the component-side inner contour (18) and the steering rod-side outer contour (17) is perceptible as an indication of the malfunction and/or failure of the first anti-rotation component (15).

8. The steering gear according to claim 1, wherein an outer circumference of the second anti-rotation component (16) has a component-side retaining contour (20) which cooperates with a housing-side retaining contour (21) of the steering rod housing (11) designed to correspond to the component-side retaining contour (20) for fixing the second anti-rotation component (16) to the steering rod housing (11), in particular the housing-side retaining contour (21) is formed on an inner side (14) and/or front side (22) of the steering rod housing (11).

9. The steering gear according to claim 8, wherein the component-side retaining contour (20) has multiple projections (23) and/or recesses (24) alternating in the circumferential direction around the central longitudinal axis (5), wherein the housing-side retaining contour (21) has further housing-side recesses (25) and/or further projections (26) corresponding to the component-side projections (23) and/or recesses (24), in particular the second anti-rotation component (16) is fixed due to the interaction of the component-side projections (23) and/or recesses (24) with the housing-side further recesses (25) and/or further projections (26) for blocking a rotational movement around the central longitudinal axis (5).

10. A steer-by-wire steering device with a steering gear (1) according to claim 1.
